(19) United States
(12) Patent Application Publication
(10) Pub. No.: US 2008/0232519 A1
(43) Pub. Date: Sep. 25, 2008

(54) METHOD AND APPARATUS FOR COMPENSATING CHANNEL CHANGES FOR FAST FADING CHANNELS

(75) Inventor: QIN LIU, Fremont, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 11/688,249

(22) Filed: Mar. 19, 2007

(51) Int. Cl. H04J 11/00

(52) U.S. Cl. 375/346; 370/208; 375/267; 375/347

(57) ABSTRACT

A method for compensating channel changes in an OFDM system is provided. The method comprises the steps of: providing at least two PN sequences; and using the parameters of the at least two PN sequences for determining a set of compensated values of data disposed between the at least two PN sequences.

### FIELD OF THE INVENTION

The present invention relates generally to compensating channel changes, more specifically the present invention relates to compensating channel changes in an OFDM system.

### BACKGROUND

In a TDS-OFDM system, known PN is positioned ahead of its associated IFFT data. The known PN and the associated IFFT data comprise one symbol. At the receiving side, PN is removed, FFT is applied to data, and one-step equalization results in transmitted symbol. However, in time-varying multipath channels, channel changes between frames introduce inter-carrier-interference.

Therefor, it is desirous to have a way for compensating the changes.

### SUMMARY OF THE INVENTION

A method for compensating channel changes in an OFDM system is provided. The method comprises the steps of: providing at least two PN sequences; and using the parameters of the at least two PN sequences for determining a set of compensated values of data disposed between the at least two PN sequences.

A receiver comprising a compensator, wherein the compensator comprises a method for compensating channel changes in an OFDM system is provided. The method comprises the steps of: providing at least two PN sequences; and using the parameters of the at least two PN sequences for determining a set of compensated values of data disposed between the at least two PN sequences.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a TDS-OFDM frame structure in accordance with some embodiments of the invention.

FIG. 2 is an example a receiver or a portion thereof in accordance with some embodiments of the invention.

FIG. 3 is a flowchart in accordance with some embodiments of the invention.

FIG. 4 is diagram in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to compensating channel changes in an OFDM system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of compensating channel changes in an OFDM system described herein. The non-processor circuits may include, but are not limited to, a radio receiver, a radio transmitter, signal drivers, clock circuits, power source circuits, and user input devices. As such, these functions may be interpreted as steps of a method to perform compensating channel changes in an OFDM system Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

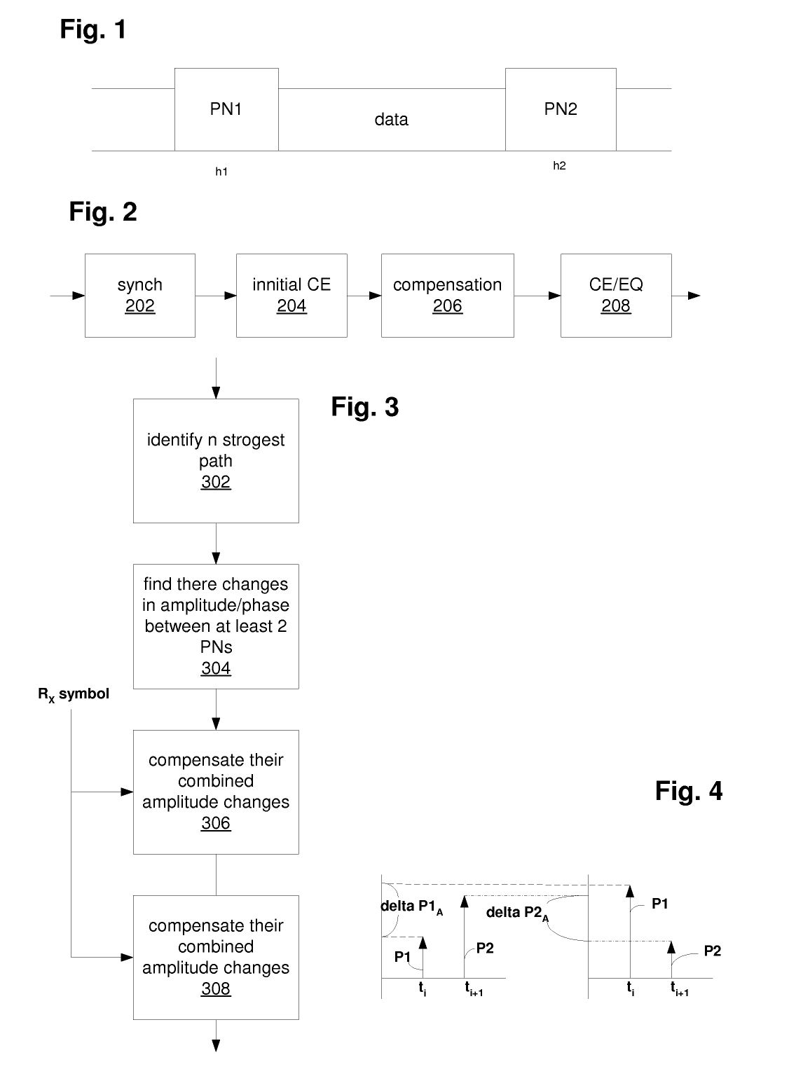

Referring to FIGS. 1-4, depictions of the present invention are shown. In FIG. 1, a TDS-OFDM frame structure is shown. A packet of transmission or a received packet having PN sequence as guard intervals is shown. The packet is positioned sequentially within a frame among a multiplicity of packets. As can be appreciated, PNs are disposed between the OFDM symbols. It is noted that the present invention contemplates using the PN sequence disclosed in U.S. Pat. No. 7,072,289 to Yang et al which is hereby incorporated herein by reference. More specifically, PN1 corresponds to a channel characteristics h1, and PN2 corresponds to a channel characteristics h2. As can be seen, in time-varying multipath channels, channel changes between frames introduce inter-carrier-interference. The present invention addresses this issue by introducing a compensation for the time-varying multipath channels.

FIG. 2 shows where the compensation happens in a typical receiver (only part of the receiver is shown). The received information goes through a synchronization block 202. The synchronized information goes through an initial channel estimation block 204. The initially estimated information are subjected to a compensation 206 which is further explained in FIGS. 3-4 in which the time-varying multipath channels are compensated. The compensated information further undergoes one more channel estimation and equalization 208 process such as FFT (fast Fourier transform), etc.

In FIG. 3, a flowchart 300 for compensation 206 is shown. A set of n channel characteristics such as h1 and h2 coming from the initial channel estimation block 204 is first subjected to an identification, wherein at least 1 strongest paths are identified (Step 302). As a general matter, n can be a natural number greater than or equal to two (n≧2). The amplitude and phase change of h1 and h2 are determined (Step 304). Data information within a frame is compensated based upon the amplitude determination (Step 306). Data information within a frame is compensated based upon the phase determination (Step 308). Again, as a general matter, PN sequences such h1 or h2 are elements of a set h_{PN} all of which are contemplated in the present invention. Repeat Steps 306 and 308 if more received symbols and sufficient time are available. This way, the data information, or R_{X} symbol, interposed between h1 and h2 in a time-varying multipath channels is compensated.

In FIG. 4, a diagram depicting the compensation is shown. Assuming a channel has two significant paths P1 and P2. Their respective channel relating to PN1 and PN2 are h1 and h2. Each path may change from time from the time at PN1 to PN2, or more generally from the time at PNᵢ to PNᵢ₊₁. The changes comprises amplitude change and phase change. The amplitude change is depicted in the figure as ΔP_{A} for a path. Therefore, for path 1 (P1), amplitude change is depicted as ΔP_{A1} and for path 2 (P2), amplitude change is depicted as ΔP_{A2}. Similarly, phase change ΔP_{PH} (not shown) can be obtained. Based on the phase and amplitude change or changes, compensation for data interposed between the PNs results. The compensation may be a simple arithmetic average, or other more elaborate, weighted averages.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. A method for compensating channel changes in an OFDM system, the method comprising the steps of:
providing at least two PN sequences; and
using the parameters of the at least two PN sequences for determining a set of compensated values of data disposed between the at least two PN sequences.

2. The method of claim 1, wherein the at least two PN sequences comprise two consecutive PN sequences.

3. The method of claim 1, wherein the parameters comprise amplitude information.

4. The method of claim 1, wherein the parameters comprise phase information.

5. The method of claim 1, wherein the OFDM system comprises a TDS-OFDM system.

6. The method of claim 1, wherein the set of compensated values is obtained via averaging.

7. The method of claim 1, wherein the channel changes comprise changes in at least one fast fading channel.

8. A receiver comprising a compensator, wherein the compensator comprises a method for compensating channel changes in an OFDM system, the method comprising the steps of:
providing at least two PN sequences; and
using the parameters of the at least two PN sequences for determining a set of compensated values of data disposed between the at least two PN sequences.

9. The receiver of claim 8, wherein the at least two PN sequences comprise two consecutive PN sequences.

10. The receiver of claim 8, wherein the parameters comprise amplitude information.

11. The receiver of claim 8, wherein the parameters comprise phase information.

12. The receiver of claim 8, wherein the OFDM system comprises a TDS-OFDM system.

13. The receiver of claim 8, wherein the set of compensated values is obtained via averaging.

14. The receiver of claim 8, wherein the channel changes comprise changes in at least one fast fading channel.
